(19) United States
(12) Patent Application Publication
(10) Pub. No.: US 2006/0181773 A1
(43) Pub. Date: Aug. 17, 2006

(54) Optical element washing apparatus

(75) Inventor: Shih-Chien Yen, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/286,869

(22) Filed: Nov. 23, 2005

(30) Foreign Application Priority Data
Dec. 30, 2004 (CN) 200420103610.6

(51) Int. Cl. G02B 27/44

(52) U.S. Cl. 359/565

(57) ABSTRACT

An optical element washing apparatus (100) includes a holding frame (10) and a plurality of clamping poles (20a, 20b, 20c). The holding frame includes a top board (11) and a bottom board (12), and each of the top board (11) and the bottom board (12) has a plurality of guiding slots (14a, 14b, 14c; 15a, 15b, 15c) formed therethrough. Each clamping pole has a plurality of V-shaped grooves (21) defined therein. The clamping poles, in part, extend through the guiding slots and can be moved along at least one of the guiding slots and connected with the holding frame. The plurality of clamping poles, together with the V-shaped grooves, are used for holding a plurality of optical elements at a time. Therefore, the optical element washing apparatus has a high washing efficiency and can be used in washing batches of optical elements.

### BACKGROUND OF THE INVENTION

1. Field of the Invention

The present invention relates to washing apparatuses and, in particular, to an optical element washing apparatus for cleaning lenses.

2. Discussion of the Related Art

Nowadays, optical elements such as lenses are commonly used in digital cameras or digital video recorders. There is more and more demand for higher quality and serviceability of these optical elements. A film such as an antireflective film or an infra-red cut film is generally plated on the optical elements, especially on lenses. To improve imaging quality, it is an important first step to wash the optical elements before plating a film thereon. How to wash optical elements effectively before plating is an important technology.

Usually, optical elements are washed by a concussion of ultrasonic waves in a vessel filled with liquid. For example, referring to FIG. 3, P.R. China Patent No. 99234336.4 discloses an optical element washing apparatus. The optical element washing apparatus includes a washing box 1, a vessel 2, and an engine 3. The washing box 1 is a sealed cylinder including a cover 4 and is filled with a kind of liquid 5 and a lens 6. The vessel 2 is a sealed vessel, including a top portion and a bottom portion. The top portion is filled with water 7 and the washing box 1 is floated in the water 7. The engine 3 is mounted in the bottom portion and can produce the concussion of ultrasonic waves. The concussion of ultrasonic waves can transmit to the washing box 1 via the water 7 in the top portion. Thus, the lens 6 can be washed by the liquid 5. However, the optical element washing apparatus can only wash lenses one by one. Therefore, the efficiency of the optical element washing apparatus is low, and this prior art washing apparatus is not practical for washing large numbers of optical elements within a short period of time.

What is needed, therefore, is an optical element washing apparatus which has high washing efficiency and can be used in washing optical elements in mass quantities.

### SUMMARY OF THE INVENTION

In a preferred embodiment herein, an optical element washing apparatus includes a holding frame and a plurality of clamping poles. The holding frame includes a top board and a bottom board. Each of the top board and the bottom board defines a plurality of guiding slots. Each clamping pole has a plurality of V-shaped grooves defined therein. The clamping poles pass through the plurality of guiding slots, and at least one of the clamping poles can be moved along at least one of the guiding slots and connected with the holding frame.

The plurality of clamping poles with the plurality of V-shaped grooves are used for holding a plurality of optical elements at a time. Therefore, the optical element washing apparatus has high washing efficiency and can be used in washing optical elements in mass quantities. In addition, the V-shaped grooves of the clamping poles can increase the exposed area of the optical elements so that the optical elements can be washed even more effectively.

Other advantages and novel features will become more apparent from the following detailed description of preferred embodiments when taken in conjunction with the accompanying drawings.

### BRIEF DESCRIPTION OF THE DRAWINGS

Many aspects of the present optical element washing apparatus can be better understood with reference to the following drawings. The components in the drawings are not necessarily to scale, the emphasis instead being placed upon clearly illustrating the principles of the present apparatus. Moreover, in the drawings, like reference numerals designate corresponding parts throughout the several views.

FIG. 1 is an isometric view of the optical element washing apparatus, in accordance with a preferred embodiment;

FIG. 2 is an isometric view of the clamping pole of the optical element washing, apparatus in accordance with another preferred embodiment; and

FIG. 3 is a schematic view of a conventional optical element washing apparatus.

### DETAILED DESCRIPTION OF THE EMBODIMENTS

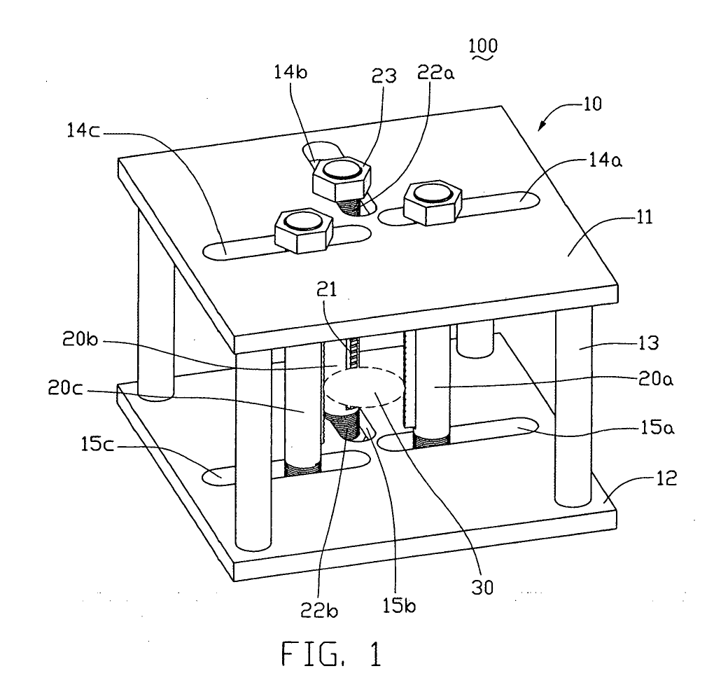

Referring to FIG. 1, in a preferred embodiment, an optical element washing apparatus 100 includes a holding frame 10, a plurality of clamping poles 20a, 20b, 20c, and a plurality of nuts 23.

The holding frame 10 incorporates a top board 11, a bottom board 12, and a plurality of holding poles 13. The top board 11 and the bottom board 12 are advantageously rectangular or square, as such shapes promote a close packing of multiple holding frames in a given space. The holding poles 13 are provided between the top board 11 and the bottom board 12 and are configured for holding the two boards 11, 12 at a desired spacing. The top board 11 defines three guiding slots 14a, 14b, 14c. Each guiding slot 14a, 14b, 14c is strip shaped and are arrayed in a T-shape. Corresponding to the three guiding slots 14a, 14b, 14c, the bottom board 12 also defines three guiding slots 15a, 15b, 15c. It is to be understood, however, that each board 11, 12 could have other corresponding numbers and arrays of guide slots 14 and 15 and still be within the scope of the present optical element washing apparatus.

Each of the clamping poles 20a, 20b, 20c defines a plurality of V-shaped grooves 21. Further, each of the clamping poles 20a, 20b, 20c has screw threads 22a, 22b at two opposite ends thereof. The length of the clamping poles 20a, 20b, 20c is slightly longer than the distance between top surface of the top board 11 and the bottom surface of the bottom board 12. Just as the number of slot pairs 14, 15 could vary, the number of clamping poles 20 would advantageously match the number of slot pairs 14, 15. Alternatively, though, it may prove useful to have more slot pairs 14, 15 than the number of clamping poles 20 actually employed to allow for a variety of placement choices for clamping poles 20. Such a variety of choices would allow for a variety of lens sizes, as well as a various number of lenses, to be accommodated by a given optical element washing apparatus 100.

In assembly, the clamping pole 20a passes through the guiding slot 14a of the top board 11 and through the guiding slots 15a of the bottom board 12. The two ends with screw threads 22a, 22b, respectively, extend out from the top board 11 and the bottom board 12. Two of the nuts 23 are respectively engaged with the screw threads 22a, 22b so that the clamping pole 20a can be connected with the holding frame 10 in a definite position. In a similar fashion, the clamping poles 20b, 20c extend through a respective pair of the guiding slots 14b, 15b, and 14c, 15c, and can be fixed in a definite position of the holding frame 10 by using nuts 23.

In use, the clamping poles 20a, 20b, 20c, are assembled to the holding frame 10 and the nuts 23 are loosened. Then, the V-shaped grooves 21 of the clamping poles 20a, 20b, 20c can act together to hold a plurality of optical elements 30 (one of which is shown in phantom in FIG. 1) therebetween. Next, the nuts 23 are tightened and the optical element washing apparatus 100 is put in a liquid for cleaning of the optical elements 30.

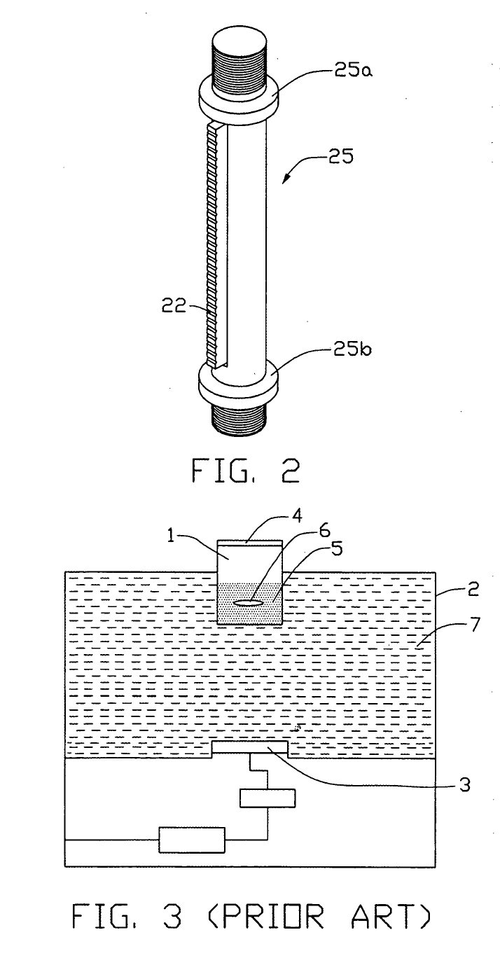

Referring to FIG. 2, in another preferred embodiment, each of the clamping poles 20a, 20b, 20c are replaced by an alternative clamping pole 25. The clamping pole 25 has a plurality of V-shaped grooves 22 defined therein. The primary difference between clamping pole 25 and the clamping poles 20a, 20b, 20c is that each clamping pole 25 has two ends, and each end has a respective flange 25a, 25b. In assembly, the flanges 25a, 25b, respectively, would resist the top board 11 and the bottom board 12, and, thus, the clamping poles 25, in conjunction with their respective flanges 25a, 25b, are suitably configured for securing the position of the two boards 11, 12, relative to each other. Thus, in this embodiment, the plurality of holding poles 13 can be omitted, if desired.

In other alternative embodiment, the three guiding slots 14a, 14b, 14c can also be arrayed in a Y-shape, and/or one of the three plurality of clamping poles 20a, 20b, 20c can be fixed between the top board 11 and the bottom board 12, while the other clamping poles can be moved along the guiding slots 14a, 14b, 14c. The top board 11 and the bottom board 12 can instead be circle shaped or other shaped. Further, as suggested above, the top board 11 and the bottom board 12 could include any plurality of slots 14 and 15.

It is believed that the embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

I claim:

1. An optical element washing apparatus, comprising:
a holding frame including a top board and a bottom board, the top board and the bottom board each respectively defining a plurality of guiding slots, the plurality of guiding slots in the top board and the bottom board together defining a plurality of guiding slot pairs; and
a plurality of clamping poles, each clamping pole having a plurality of V-shaped grooves therein, each clamping pole extending through a given guiding slot pair, at least one clamping pole being configured for movement along at least one of the guiding slots, at least one clamping pole being connected with the holding frame.

2. The optical element washing apparatus as claimed in claim 1, wherein the top board and the bottom board are at least one of rectangular and square in shape.

3. The optical element washing apparatus as claimed in claim 1, wherein a plurality of holding poles are provided between the top board and the bottom board, each holding pole being configured for holding the top board and the bottom board in place relative to one another.

4. The optical element washing apparatus as claimed in claim 1, wherein each of the clamping poles comprises two opposite ends with screw threads.

5. The optical element washing apparatus as claimed in claim 4, wherein the optical element washing apparatus further comprises a plurality of nuts, the plurality of nuts respectively engaging with the screw threads.

6. The optical element washing apparatus as claimed in claim 1, wherein the length of the clamping pole is longer than the distance between top surface of the top board and the bottom surface of the bottom board.

7. The optical element washing apparatus as claimed in claim 1, wherein the clamping pole comprises two ends, each end having a respective flange associated therewith, each flange respectively resisting one of the top board and the bottom board, each clamping pole and the respective pair of flanges associated therewith together being configured for securing the position of the top board relative to the bottom board.

8. The optical element washing apparatus as claimed in claim 1, wherein the top board defines three guiding slots, and each guiding slot is strip shaped.

9. The optical element washing apparatus as claimed in claim 8, wherein the three guiding slots are arrayed in a T-shape.

10. The optical element washing apparatus as claimed in claim 1, wherein the V-shaped grooves corresponding to the clamping poles are configured for acting together to hold at least one optical element therebetween.
